(19) United States
(12) Patent Application Publication
(10) Pub. No.: US 2014/0207571 A1
(43) Pub. Date: Jul. 24, 2014

(54) SYSTEMS AND COMPUTER-IMPLEMENTED PROCESSES FOR DELIVERING PERSONALIZED DEALS TO CUSTOMERS

(71) Applicants: Luke Hammock, Washington, DC (US); Janusz Niczyporuk, Vienna, VA (US); Bor J. Sun, San Francisco, CA (US); Joseph O'Brien, San Francisco, CA (US)

(72) Inventors: Luke Hammock, Washington, DC (US); Janusz Niczyporuk, Vienna, VA (US); Bor J. Sun, San Francisco, CA (US); Joseph O'Brien, San Francisco, CA (US)

(73) Assignee: Capital One Financial Corporation, McLean, VA (US)

(21) Appl. No.: 14/145,582

(22) Filed: Dec. 31, 2013

Related U.S. Application Data
(60) Provisional application No. 61/755,306, filed on Jan. 22, 2013.

(51) Int. Cl. G06Q 30/02

(52) U.S. Cl. CPC G06Q 30/0255
USPC 705/14.53

(57) ABSTRACT

Systems and processes are disclosed for generating an delivering personalized deals to users. In certain embodiments, disclosed embodiments may configure a financial service account associated with a user. Based on monitored transactions from the financial service account, systems consistent with disclosed embodiments may generate deals that are personalized to the user of the financial service account. Such deals may be delivered to the user or a third-party upon request.

### PRIORITY CLAIM

This disclosure claims priority under 35 U.S.C. §119 to U.S. provisional patent application No. 61/755,306 filed on Jan. 22, 2013, and entitled “Systems and Computer-Implemented Processes for Delivering Personalized Deals to Customers.” The aforementioned application is incorporated herein by reference in its entirety.

### FIELD

The present disclosure is related to the delivery of personalized deals. More particularly, the disclosure relates to methods and systems for delivering deals that are personalized based on a consumer's spending habits.

### BACKGROUND

An acute understanding of consumer spending patterns leads to more effective marketing campaigns. That is, advertisers realize better gains when they tailor deals to consumers based on individualized metrics, such as spending patterns. As used, the term “deal” refers broadly to discounts, coupons, rewards, advertisements or other incentives related to any product or service. For example, an advertiser may present a consumer with a deal that discounts a product the consumer previously purchased in hopes that the consumer continue (or increase) consumption of that product. Likewise, consumers may receive deals on goods or services that complement, or are collateral to, known purchases. In this manner, an advertiser—knowing that a customer recently purchased a new set of golf clubs—could present personalized deals for golf balls or other golfing merchandise to the consumer. Such marketing campaigns achieve better results because consumers are more likely to use deals personalized according to their actual spending patterns.

Further, consumer spending patterns could be used in conjunction with other relevant information to create and deliver even more effective deals. For example, deals may also be personalized using dynamic data such as the consumer's geographic location, type of transaction (e.g., necessary versus luxury goods), or timing of the purchase (e.g., knowing that a consumer purchases a new electronic device every six months, an advertiser could send that consumer deals related to electronics every six months).

To provide consumers with personalized deals as disclosed above, advertisers must have access to individual purchase transactions associated with a financial service account (e.g., a bank account). Due to strict privacy laws and other regulations, advertiser access to such information is extremely limited; financial service providers, however, do have unrestricted access to the financial service accounts they manage. The term “financial service provider” refers to any savings, loans, or investment entities, including banks, credit unions, or brokerage institutions. Indeed, financial service providers routinely monitor individual purchase transactions associated with their financial service accounts.

In general, these providers meticulously record and monitor consumer transactions for fraud or as a means to provide their customers with an accurate accounting statement. These transaction records often include, among other things, the amount tendered, the vendor description and classification, the time and location of the transaction, the form in which the transaction occurred (e.g., credit or debit). With such information, financial service providers are uniquely positioned to generate and deliver deals that are personalized to a consumer based on his or her spending patterns.

### SUMMARY

Methods and systems are disclosed for delivering personalized deals. In one embodiment, the method includes configuring a financial service account, associated with a user and monitoring transactions performed using the financial service account. The method may further include generating personalized deals based on the monitored transactions and receiving a request for the generated personalized deals. The method may also include providing the personalized deals.

In another embodiment, a system is disclosed including a memory storing software instructions and a processor configured to execute the instructions to configure a financial service account associated with a user and monitor transactions performed using the financial service account. The processor may further be configured to generate a personalized deal based on the monitored transactions and receive a request for the generated personalized deal. The processor may also be configured to provide the personalized deal based on the request.

Additional objects and advantages of the disclosure will be set forth in part in the description which follows, and in part will be obvious from the description, or may be learned by practice of the disclosure. The objects and advantages of the disclosure will be realized and attained by means of the elements and combinations particularly pointed out in the appended claims.

It is to be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure. In the drawings:

FIG. 1 illustrates an exemplary system environment in which the features of the present disclosure may be implemented;

FIG. 2 illustrates an exemplary deal engine consistent with the principles of the present disclosure;

FIG. 3 is a flowchart of an exemplary deal delivery process consistent with the principles of the present disclosure;

FIG. 4 is a flowchart of an exemplary deal generation process consistent with the principles of the present disclosure;

FIG. 5 is a flowchart of an exemplary deal delivery process using an application interface consistent with principles of the present disclosure;

FIG. 6 is a flowchart of an exemplary deal delivery process using a custom identification consistent with principles of the present disclosure;

FIG. 7 illustrates an exemplary deal delivery scenario where an embodiment of the present disclose may be obtained from an application store.

FIG. 8 illustrates an exemplary configuration for delivering deals using an Application Programming Interface; and

FIG. 9 illustrates an exemplary system environment in which features of the present disclosure may be implemented using an Application Programming Interface.

### DETAILED DESCRIPTION

The following detailed description refers to the accompanying drawings. Wherever possible, the same reference numbers are used throughout the drawings to refer to the same or like parts. While several exemplary embodiments and features of the disclosure are described herein, modifications, adaptations, and other implementations are possible without departing from the spirit and scope of the disclosure.

Generally, the present disclosure is directed to methods and systems for delivering to users deals that are personalized based on a consumer's spending habits. In one embodiment, a financial service provider (e.g., bank, credit card company, etc.) may configure a financial service account (e.g., credit card, checking account, debit account, etc.) for a user of the account. The financial service provider may be configured to monitor and record transactions associated with the user's financial service account. Using this record of transactions, the financial service provider may perform one or more processes to generate personalized deals based on the user's spending patterns. These personalized deals may be linked to the user's financial service account. The financial service provider may be configured to deliver these deals directly to the user or via a valid client request.

The financial service provider may deliver the personalized deals to requesting third-party clients. To do so, the financial service provider may be configured to receive user-identifying information (e.g., credit card number, social security number, name or other unique identification) from a client application. On receipt of a valid request, the financial service provider may deliver to the client one or more personalized deals associated with that user's financial service account. In some embodiments, the client may be configured to provide a payment to the financial service account provider managing the financial service account associated with the user.

The above noted features and other aspects and principles of the present disclosure may be implemented in various environments, including computer-based environments that use, for example, personal computers, workstations, servers, laptops, personal digital assistants (PDAs), mobile phones, handheld devices and the like. The disclosed embodiments may also be implemented using other types of electronic and non-electronic environments, such as, for example, post mail, radio, and television systems and/or infrastructures.

The phrase “and/or” as used with regard to a list of items means that any one of the items may constitute the described group of items or alternatively any combination of the items may constitute the described group.

The disclosed embodiments may also include computer program products that are stored in a computer-readable medium. Network environments may be provided to link or connect components in the disclosed systems. Networking environments are commonplace in offices, enterprise-wide computer networks, intranets and the Internet (i.e., the World Wide Web). Such networks may include a wired and/or wireless network, such as, for example, a local area network (LAN), a wide area network (WAN), storage area network (SAN), a public switched telephone network (PSTN), an Integrated Services Digital Network (ISDN), an infrared (IR) link, a radio link, such as a Universal Mobile Telecommunications System (UMTS), Global System for Mobile Communications (GSM), Code Division Multiple Access (CDMA), broadcast radio network, cable television network, and a satellite link.

Further, embodiments may be implemented using various types of transmission protocols and data formats, such as, for example, transmission control protocol/internet protocol (TCP/IP), hyper text transfer protocol (HTTP), secure HTTP, wireless application protocol (WAP), hyper text markup language (HTML), extensible markup language (XML), Standard Generalized Markup Language (SGML), etc.

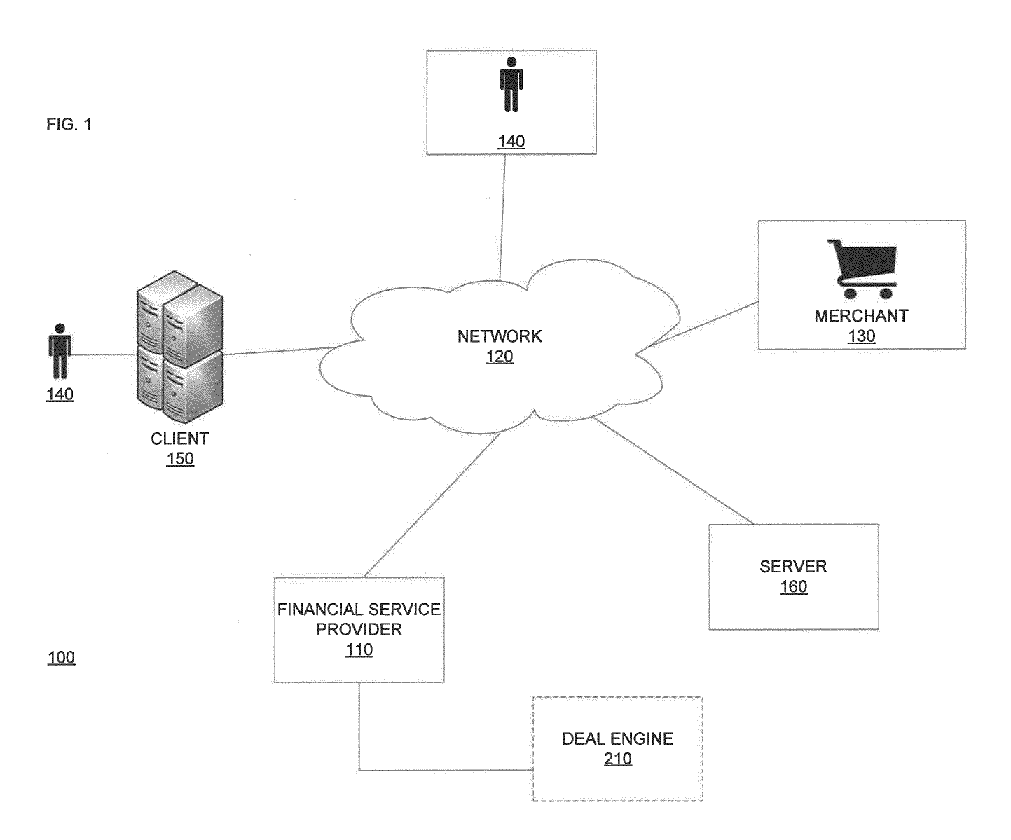

FIG. 1 illustrates an exemplary system environment 100 in which the features and principles of this disclosure may be implemented. As illustrated in FIG. 1, system 100 may include a financial service provider 110, network 120, merchant 130, user 140, client 150, and server 160.

Financial service provider 110 may represent one or more entities that configure, offer, and manage financial service accounts, such as credit cards, to one or more consumers, such as user 140. For example, financial service provider 120 may be a bank, a credit card company, or other institutions that provides financial service accounts for consumers (e.g., user 140). In one aspect, financial service provider 110 may include components and infrastructure known to be used by such entities to perform financial service provider functions and operations. For example, financial service provider 110 may include one or more computing devices, servers, processors, memory devices, databases, and the like that perform processes through the execution of software instructions and other processing mechanisms. When referring to functionalities performed by financial service provider 110, one of ordinary skill in the art would understand that those functionalities include processes to be performed by a processor that executes software.

In one aspect, financial service provider 110 configures (using processing components and memory) one or more financial service accounts associated with one of more users, including, for example, user 140. The financial service accounts may be used to purchase goods and/or services from various sources, including, for example, merchant 130. A financial service account may be a loan, credit card line of credit, checking or savings account, gift payment, or any type of account associated with financial services for a user 140.

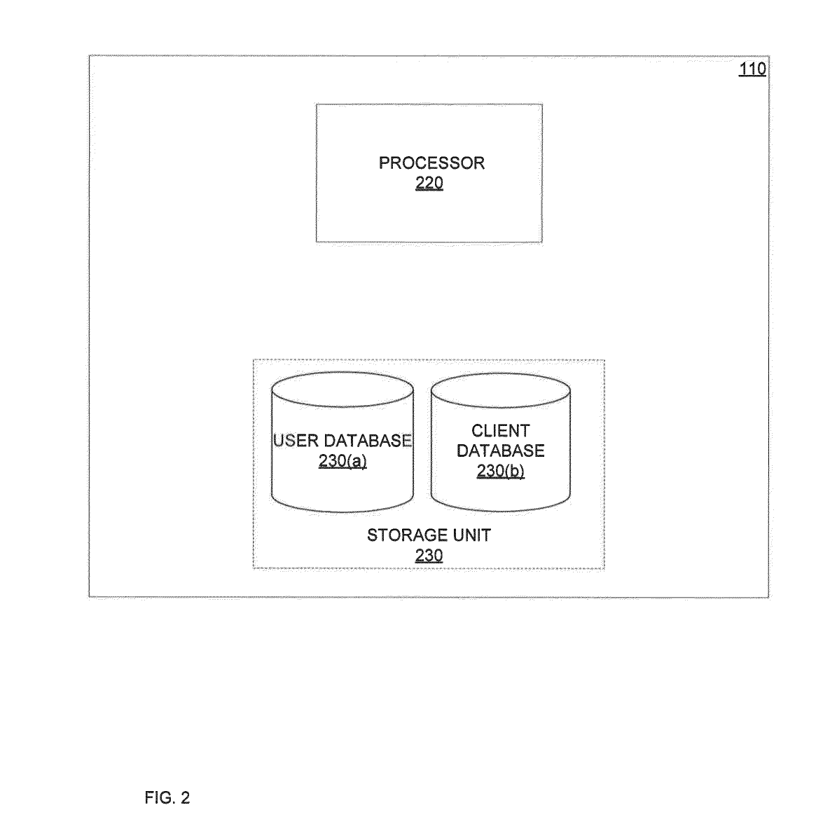

FIG. 2 shows and an exemplary financial service provider 110 including a one or more processors 220, and storage unit 230. Other components may be included in financial service provider 110 that are not shown that one skilled in the art would understand to exist to enable provider 110 to perform financial service provider functions and functions consistent with the disclosed embodiments.

Processor 220 may be one or more processors, such as a microprocessor from the Pentium™ family manufactured by Intel™ or the Turion™ family manufactured by AMD™. Processor 220 may include a single core or multiple core processor system that provides the ability to perform parallel processes simultaneously. For example, processor 220 may be a single core processor that is configured with virtual processing technologies known to those skilled in the art. In certain embodiments, processor 220 may use logical processors to simultaneously execute and control multiple processes.

Processor 220 may implement virtual machine technologies, or other similar known technologies to provide the ability to execute, control, run, manipulate, store, etc. multiple software processes, applications, programs, etc. In another embodiment processor 220 may include a multiple-core processor arrangement (e.g., dual or quad core) that is configured to provide parallel processing functionalities to allow deal engine 210 to execute multiple processes simultaneously. One of ordinary skill in the art would understand that other types of processor arrangements could be implemented that provide for capabilities disclosed herein.

In another embodiment, processor 220 may be configured to process components that enable and process communications between remote entities through network 120 or any other suitable communications infrastructure. For instance, processor 220 may be configured to perform one or more processes consistent with embodiments of the present disclosure. Processor 220 may include more than one processing devices, memory devices, interface devices, data, and executable software that allows deal engine 210 to generate personalized deals consistent with embodiments of the present disclosure.

Storage unit 230 may be one or more storage devices that store information associated with certain aspects of the present disclosure. For example, storage unit 230 may include a customer database 230(a), and a client database 230(b). Although the customer and client databases 230(a) and 230(b) are shown as two distinct databases within storage unit 230, embodiments of the present disclosure are not limited to this configuration. For instance, databases 230(a) and 230(b) may be combined into a single storage unit or distributed across multiple storage units. Storage unit 230 may also include one or more processors that perform storage access and control functions for storage unit 230.

In one embodiment, customer database 230(a) may store user-specific information. For example, user database 230(a) may store data reflecting a user name, address, demographic information, financial status, and other user-related information. In another embodiment, customer database 230(a) may store information about the user's past purchases, including, for example, the transaction amount, type, and location. Such information may be collected by the point-of-sale system by tracking purchase transactions over, for example the Visa® or MasterCard® networks (not shown). These networks, for instance, include for each transaction a Merchant Category Code (MCC) describing the merchant associated with that transaction. It is to be understood that, for users who maintain financial service accounts across multiple financial service providers, purchase history of those users may be acquired from other entities providing such information.

Financial service provider 110 may include a client database 230(b). Client database 230(b) may store information associated with subscribing clients of financial service provider 110. The term “subscribing clients” refers to clients 150 that are subscribed (e.g., registered, configured, selected, have selected, etc.) to receive personalized deals for accounts managed by the financial service provider 110. In one embodiment, client database 230(b) may store configurations related to a particular client. For example, client database may include a client name, location, the communication method between the client and financial service provider, types and quantity of deals to be delivered to the client, and the payment terms for delivery of personalized deals. It should be understood that subscribing clients may include user 140 as well as client 150.

Financial service provider 110 may include (or be associated with) a deal engine 210, which may be a software program stored in memory (e.g., storage unit 230) and executed by a processor (e.g., processor 220) to perform one or more processes consistent with certain embodiments of the present disclosure. While shown as a separate component, deal engine 210 may be included in financial service provider 110 or associated with provider 110. In other embodiments, deal engine 210 may include a processor(s) and memory device(s) storing software programs that are executed by the processor(s) for performing operations consistent with the disclosed embodiments. For example, deal engine 210 may be configured to generate and deliver personalized deals based on a financial service account associated with user 140. In another embodiment, deal engine 210 may be configured to associate personalized deals generated via a third-party to financial service accounts managed by the financial service provider 110. Deal engine 210 may be configured as a single computer such as a personal computer or server, or as a distributed computer system implemented across a number of computer devices or components, such as a computer network. In one embodiment, the components shown in FIG. 2 may reflect the components of a deal engine 210.

Network 120 may be any type of network configuration that facilitates communications between components, such as financial service provider 110 and client 150. Network 120 may be a local area network (LAN), a wide area network (WAN), a dedicated intranet, the Internet, and/or a wireless network. Further, any suitable combination of wired and/or wireless components and systems may be incorporated into network 120. Moreover, any part of network 120 may be implemented through traditional infrastructures or channels of trade to permit operations associated with financial service accounts that are performed manually or in-person by the various entities illustrated in FIG. 1.

Merchant 130 may be one or more merchants associated with any individual, group or business entity that provides goods and/or services that may be purchased by consumers, such as user 140. For example, merchant 130 may represent a vendor that offers goods that are purchased by user 140 using one or more of the financial service accounts managed by financial service provider 110. A good may be any type of tangible or intangible item that may be sold to one or more users 140. In an exemplary embodiment, a merchant 130 may be an automobile dealership that sells automobiles as goods to consumers, such as a user 140.

A “good,” however, is not limited to any type of automobile or type of good. As such, systems and methods consistent with certain embodiments of the present disclosure may be associated with any types of motorized or non-motorized purchases, such as for example, motorcycles, trailers, music, airplanes, groceries, etc. Other non-limiting examples of goods that may be associated with the disclosed embodiments include home appliances, electronics equipment, furniture, musical instruments, computer software, etc. A service may be any type of service that merchant 130 may provide to user 140 such as a warranty service, help services, replacements and repair services, and any other type of service that may be performed by merchant 130. In certain embodiments, merchant 130 may include one or more computer systems (not shown) that process data instructions consistent with certain embodiments of the present disclosure.

Merchant 130 includes computing devices (e.g., processor(s) and memory device(s) storing computer-executable software) that perform processes consistent with the functions associated with the disclosed embodiments. For example, merchant 130 may include one or more computing devices that collect and store purchase transaction data relating to purchases made by consumers, such as user 140. Merchant 130 may include computing devices that also generate messages, and transmits the messages to components of system 100 over network 120.

User 140 may represent one or more consumers who purchases goods and/or services from merchant 130. A user 140 may also be any present or potential consumer of services provided by financial service provider 110. By a non-limiting example, a user 140 may be an existing account-holder or a potential future account-holder. For example, a user 140 may employ a financial service account, managed by financial service provider 110, to purchase goods and/or services from one or more merchants 130. Further, a user 140 may be an individual, a group of individuals, a business entity or corporation, a non-profit organization, etc. User 140 may be associated with one or more computer systems, postal mailing infrastructures, telephony components, etc. that interface with network 120 or server 160 to exchange information with financial service provider 110, merchant 130, or client 150.

Client 150 may be a computer system that performs one or more client-based processes consistent with embodiments of the present disclosure. Client 150 may include one or more processing devices, memory devices, interface devices, and software (all not shown) that allow user 140 to request, receive, and send data to and from network 120. User 140 may use client 150 to access personalized deals associated with a financial service account associated with user 140. Moreover, user 140 may exchange information with a financial service provider 110 through client 150 or directly via network 120. Client 150 may be, for example, a laptop, desktop computer, server, smartphone, PDA, tablet, or any other type of computing device. Client 150 includes components that enable communications with network 120 and enable client 150 to send and/or receive information from network 150.

Server system 160 is a computer system that performs certain processes consistent with embodiments of the present disclosure. Server system 160 may include one or more process information associated with financial service provider 110 and/or clients 150. In one embodiment, server system 160 may include a database that stores purchase transactions from the user's 140 financial service account managed by financial service provider 110. In certain embodiments, server 160 may be included in financial service provider 110. In other embodiments, server 160 may be remote from financial service provider 110.

Although FIG. 1 describes a certain number of entities within environment 100, any number of entities may be implemented. For example, more than one client 150 may be connected to network 120 that are each associated with a separate user 140. Also, many different merchants may serve many different users through network 120 or through standard channels of trade, such as face-to-face purchase transactions.

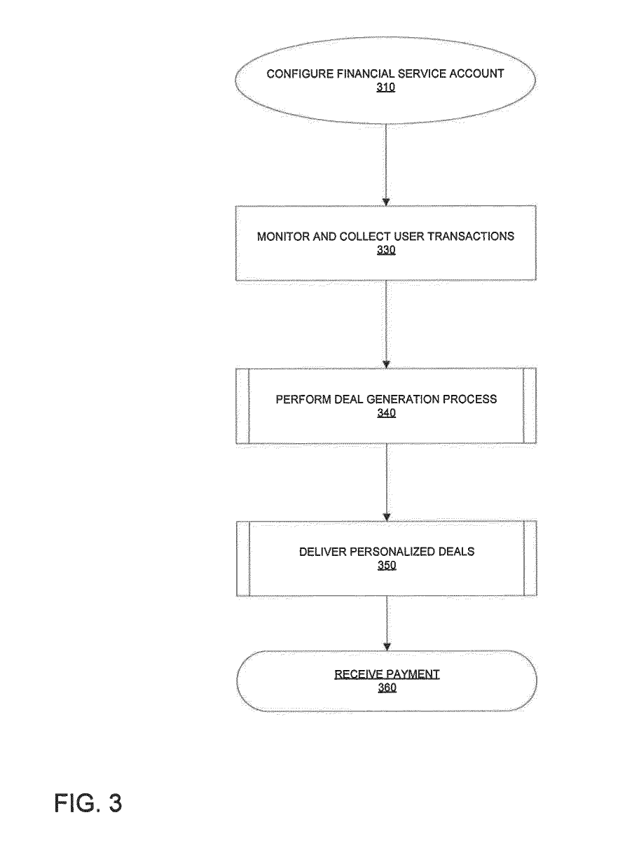

Systems and methods consistent with embodiments of the present disclosure enable a financial service provider to deliver personalized deals or incentives to users of third-party applications based on purchase transactions associated with the user's financial service account. FIG. 3 shows a flowchart of a personalized deal delivery that may be performed by a financial service provider, such as financial service provider 110. The deal delivery process may be performed according to processes consistent with embodiments of the present disclosure by an entity that does not offer or manage financial service accounts. To better illustrate the embodiments of the present disclosure, however, the deal delivery process is described in connection with user 140 holding a financial service account managed by financial service provider 110.

In one embodiment, financial service provider 110 may configure one or more financial service accounts for user 140 (Step 310). Configuring the account may include setting up a new financial service account for user 140 or reconfiguring an existing financial service account that financial service provider 110 currently manages. Financial service provider 110 may configure the financial service account by providing predetermined parameters for the account based on, for example, the profile of the user 140, such as credit worthiness, past financial performance, employment history, etc. In some instances, these parameters may include interest rate, credit limit, penalty fee conditions, financial service account usage conditions, and any other terms that may be associated with the type of financial service account provided to user 140.

In addition to financial service account parameters, financial service provider 110 may also configure parameters related to generating personalized deals consistent with embodiments of the present disclosure. For example, user 140 may select a number of categories that financial service provider 110 may use in generating personalized deals associated with the user's financial service account. For example, if user 140 selects food and dining category, financial service provider may configure a data structure (e.g., a table, array, etc.) associated with the selected category (e.g., food and dinning) to limit the deal engine 210 to only transactions related to food and dinning when generating personalized deals.

User 140 may use the configured account to purchase goods or services from merchant 130. For exemplary purposes only, and, to illustrate embodiments of the deal delivery process, user 140 may purchase goods and/or services using the financial service account managed by financial service provider 110 in accordance with Table 1. It is understood, however, that user 140 may perform any number of transactions using any combination of financial service accounts over any period of time and that the transactions listed in Table 1 are not intended to be limiting.

TABLE 1
Exemplary Transactions

| Transaction | Transaction | Transaction | Transaction | Transaction | Merchant |
|---|---|---|---|---|---|
| number | Type | Amount | Date | Description | Category |
| 1 | Debit Card | 29.00 | Oct. 1, 2012 | Supermarket | Retail Stores |
| | | | | Atlanta, GA | |
| 2 | Debit Card | 11.00 | Oct. 2, 2012 | Movie | Entertainment |
| | | | | Theaters | |
| | | | | Atlanta, GA | |
| 3 | Credit Card | 17.00 | Oct. 4, 2012 | Dry Cleaners | Personal |
| | | | | Atlanta, GA | Service |
| 4 | Debit Card | 40.00 | Oct. 6, 2012 | Burgers | Fast Food |
| | | | | Norcross, GA | |

Financial service provider 110 may monitor and collect information associated with user 140 purchase transactions. In one embodiment, financial service provider 110 receives the transactional information associated from any merchant 130 associated with the transaction. In another embodiment, if user 140 has multiple financial service accounts, financial service provider 110 may receive the user's transactional information from the respective financial service providers managing those accounts. In another embodiment, user 140 may forward to a financial service provider a copy of a financial service account statement issued by a different financial service provider containing the user's previous purchase transactions. This communication may be made electronically, (e.g., via client 150 and/or network 120) or through postal mail.

It should be noted that the above methodologies for collecting financial service account information are exemplary and embodiments of the present disclosure are not limited to the above examples. Indeed, financial service provider 110 may be configured to collect this information using other types of technologies and processes.

Following the exemplary transactions listed in Table 1, financial service provider 110 may collect the transaction information associated with user 140 and may store this data in customer database 230(a) (Step 330). Deal engine 210 may use this information to generate personalized deals consistent with certain embodiments of the present disclosure (Step 340). For instance, processor 220 may execute a program within deal engine 210 to create personalized deals—using, for example, the information stored in customer transaction database 230(a)—associated with financial service accounts.

Deal engine 210 may also be configured to deliver one or more personalized deals to client 150 (Step 350). In some embodiments, the deal engine 310 may be configured to deliver via network 120 a single deal or a group of personalized deals offered by the financial service provider 110. Further, the types of personalized deals delivered may be determined by the client 150, financial service provider 110, and/or a third party.

In some embodiments, a subscribing client, whether a user 140 or client 150, may pay a fee to the financial service provider 110 (Step 360). The term “subscribing client” refers to any party subscribed (e.g., registered, selected, configured, have selected, etc.) to receive personalized deals associated with financial service accounts managed by the financial service provider 110. For example, a subscribing client 150 may pay the financial service provider 110 a flat fee to use the financial service provider 110 as the source for retrieving and offering personalized deals. Subscribing clients 150 may also subscribe via other methods and/or means. For example, financial service provider 110, may offer a free subscription to one or more clients 150. Alternatively, a subscribing client 150 may execute an agreement with financial service provider 110 for provision of personalized deals in return for goods and/or services provided by the subscribing client.

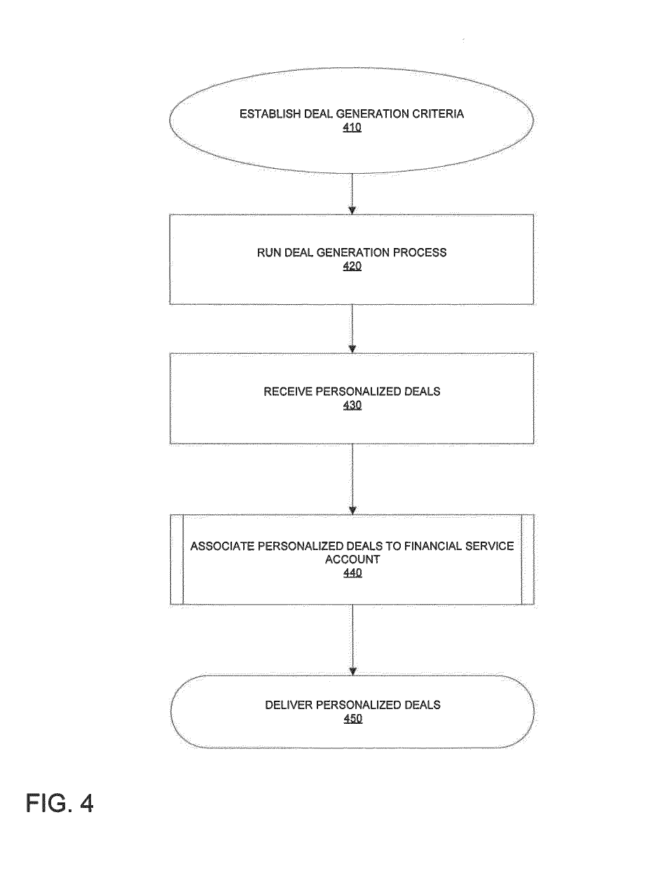

FIG. 4 shows a flowchart of an exemplary deal generation process for implementing Step 340 of FIG. 3, consistent with certain embodiments of the present disclosure. According to Step 410, financial services provider 110 may establish one or more deal generation criteria. This step may include configuring the financial service account to only use certain categories of purchase transactions to generate the deals. Financial service provider 110 may also execute software that performs a deal generation process (step 420). The software, for each financial service account associated with a user, may perform a variety of calculations to create metrics that describe each customer. For example, those metrics could describe a user's likelihood of making a purchase at a given merchant, the frequency with which the user shops at various stores or types of stores, the distance the user travels, estimated income, or favorite merchants.

In one embodiment, the personalized deals may be generated by a third party. In this embodiment, the third party may receive from financial service provider 110 purchase transactions associated with a financial service account. The third party may use this information to generate additional deals. Financial service provider 110 may receive and associate these third-party generated deals with their corresponding financial service accounts (step 430-440). The deals may be received, for example, via a batch process, modular data platform, file transfer protocol, or any other method of communication associated with network 120.

In certain aspects, financial service provider 110 delivers one or more personalized deals to user 140 according to processes consistent with embodiments of the present disclosure (step 450).

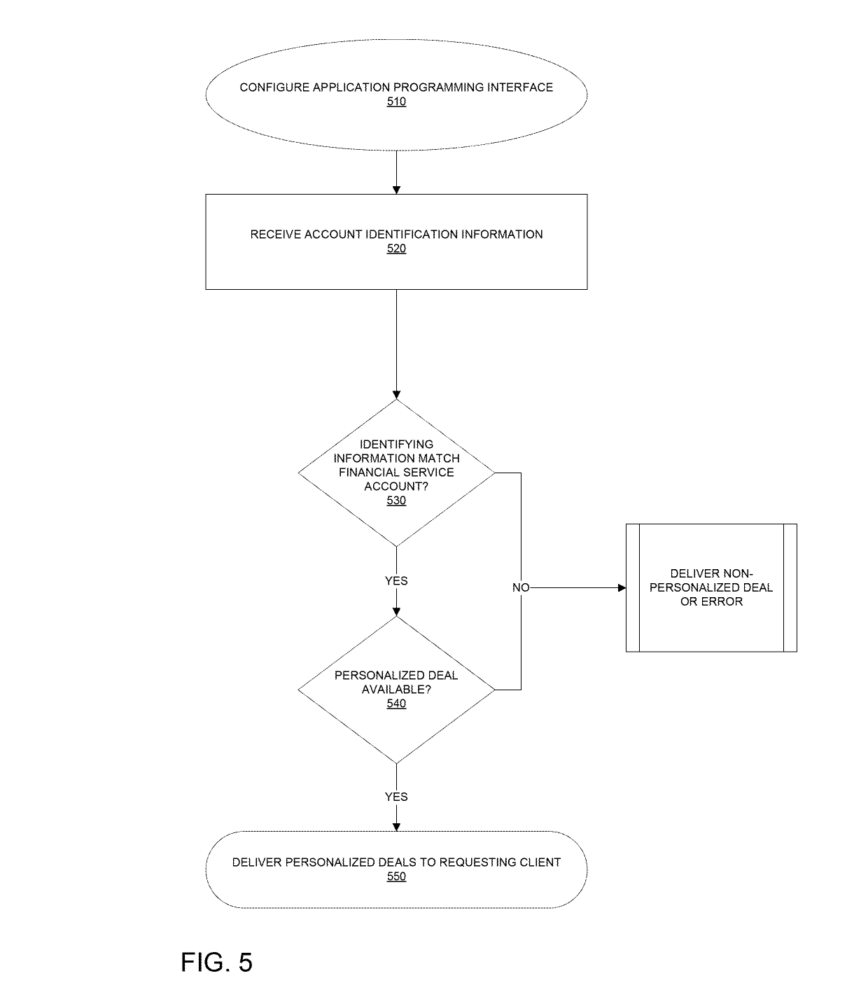

FIG. 5 shows a flowchart of an exemplary deal delivery process consistent with disclosed embodiments. In one aspect, financial service provider 110 may deliver to a client, one or more deals that are personalized to financial service accounts managed by the financial service provider. In one embodiment, financial service provider 110 may deliver the personalized deals to client 150 using an Application Programming Interface (API). An API refers to any software program code that can be used as an interface by software components to communicate with each other. An API may, for example, include specifications for routines, data structures, object classes, and variables.

Moreover, the API may be configured to define ways in which a particular task is performed. For example, deal engine 210 may be configured using an API to receive identifying financial service account information from client 150 (Step 510). This identifying information may include a credit card number, an authorization token, a mobile device ID, a custom ID, or any other information that enables financial service provider 110 to identify a user's financial service account (Step 520). The financial service provider 110 may use the identifying information to locate and deliver any personalized deals associated with that financial service account (Step 530-550). If a personalized deal is unavailable for the customer information received (Step 530-540; NO), the financial service provider 110 may return to the client 150 a non-personalized deal, an error message, or both.

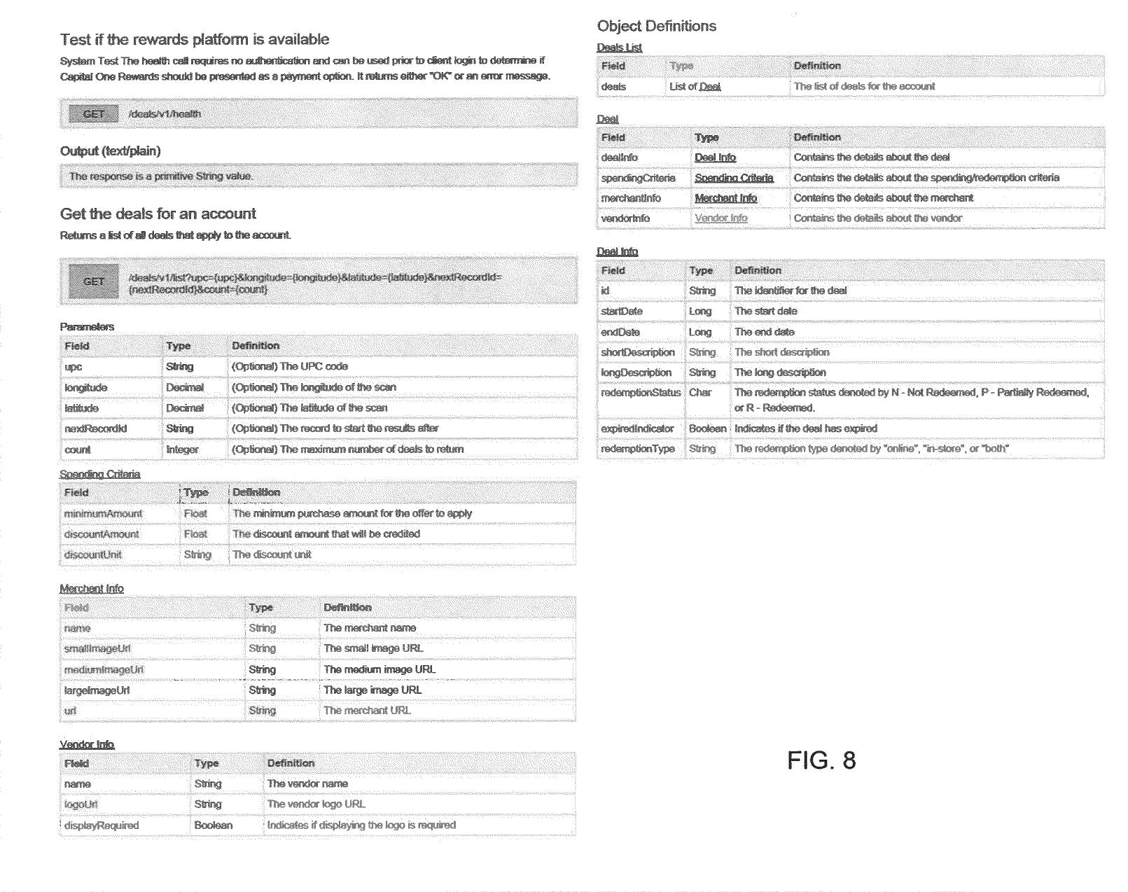

In addition, the API may be configured to deliver specific types of deals to the requesting client based on certain criteria as exemplarily disclosed in FIG. 8. In one instance, the API may return only deals that require a specific spending or redemption criteria, deals that can be redeemed online or in-store, or deals that provide the most discounts.

In one embodiment, customer identification information may include offline activity, including dynamic information, such as the current location of the user. Accordingly, the API may limit one or more deals delivered to only those that may be relevant to the user's immediate location. For example, deal engine 210 may generate three personalized deals based on a user's spending habits. These deals may include a deal related to electronics (e.g., 30% discount on a television set), a deal related to sporting goods (e.g., 20% discount on running shoes), and a deal related to automobiles (e.g., 1% interest on auto loans). Using the location of the user—as provided by the requesting client 150—the API may recognize that the user is at a dealership and only deliver the personalized deal related to automobiles to the client. In this manner, the user is not distracted by less relevant deals; thus, the likelihood of the user using the deal is significantly increased, benefiting the user, the client, and the financial service provider.

Although the above described embodiment is contemplated primarily in the context of a user's current location, aspects of the disclosed embodiments can also be applied to other user information. Indeed those skilled in the art will understand that the embodiments can be applied to personalizing deals based on the user's dynamic information including, for example, health, mood, likelihood of making a purchase, frequency with which the user shops at various stores (e.g., favorite merchants), types of stores frequented, and the user's estimated income.

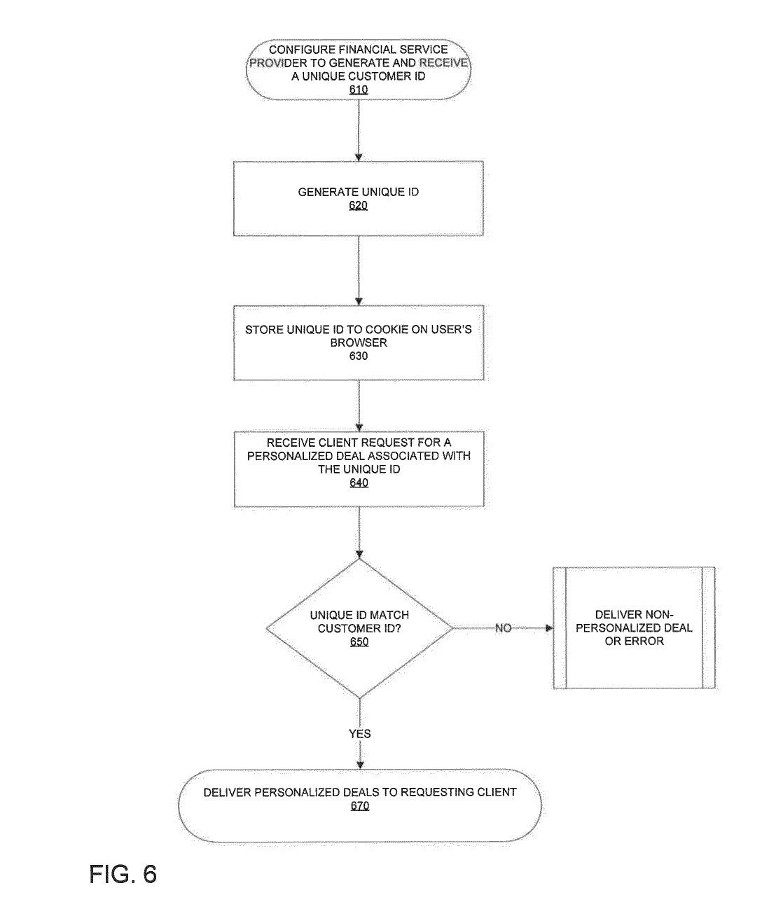

In another embodiment, financial service provider 110 may deliver personalized deals using a unique customer identification. FIG. 6 shows an exemplary flowchart of such a method. The unique customer identification may be generated by the financial service provider and placed on a user's browser. For example, financial service provider 110 may execute software to authenticate users in accessing the financial service provider's web portal (Step 610). Accordingly, in response to a user logging onto the financial service provider's website—to perhaps check account balances or view recent transactions—financial service provider 110 may generate a unique ID associated with the user's financial service account (Step 620).

Financial service provider 110 may store the unique ID in the user's web browser by copying it on to, for example, a cookie or similar program, stored in the web browser (Step 630). A cookie (i.e., an HTTP cookie, web cookie, or browser cookie) may be software program code that, when executed by a processor, compiles records of a user's web browsing history. In some embodiments, the cookie may belong to a client 150, an advertisement network, a publisher, or a merchant.

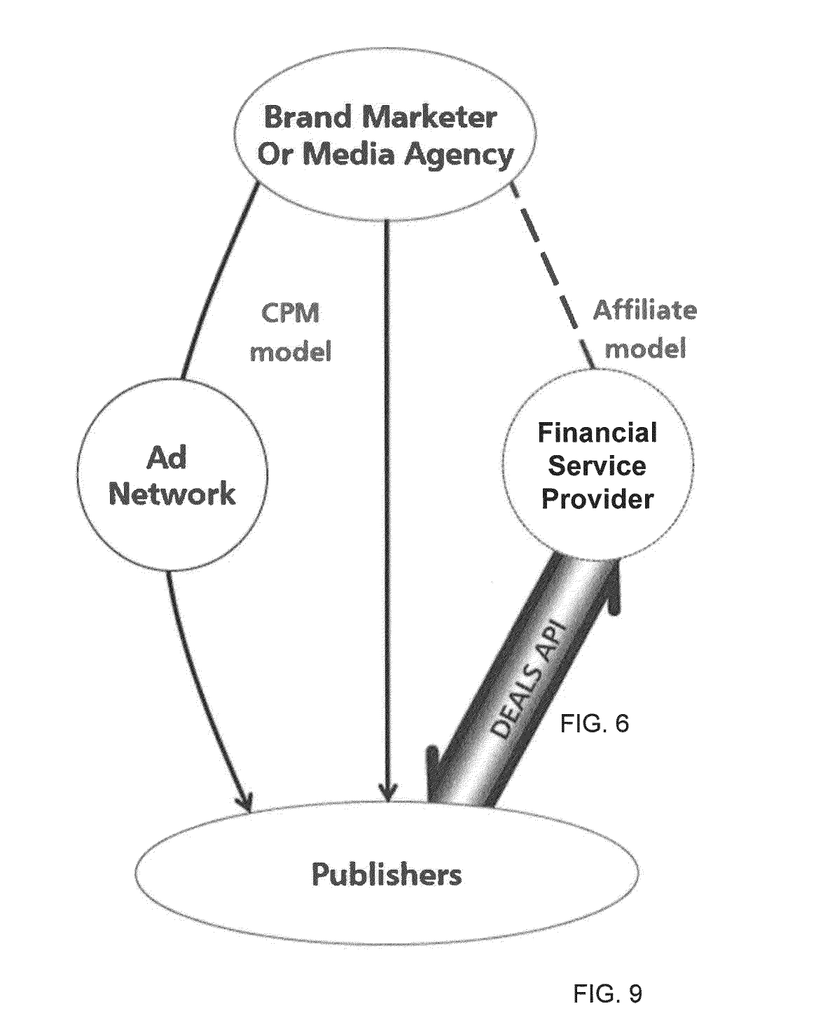

This embodiment includes using a user's offline activity (e.g., purchase transactions) to influence the user's online activity by, for example, delivering targeted online advertising to the user (e.g., via advertising network) as disclosed in FIG. 9. For example, financial service provider 110 may receive a request for a personalized deal associated with the unique ID stored on user's browser cookie (Step 640). In this instance, the owner of that cookie (e.g., the advertising network) may ping the financial service provider, asking for personalized deals associated with the unique ID (Step 640). If the unique ID matches a financial service account (Step 650), associated with the financial service provider, financial service provider 110 may deliver personalized deals associated with that account to the client (Step 670). In one embodiment, financial service provider 110 may record details of the deal delivery (e.g., time, date, clicks, etc.) and may accordingly track the financial service account associated with that deal to determine a change in user 140 behavior (e.g., whether the user used the deal to purchase a good and/or service).

It should be understood that the deals returned to client 150 via the exemplary embodiments above may take multiple forms. For example, the deals may be discounts, incentives, promotions, coupons, advertisements, or video content based on previous purchase transactions or other dynamic information associated with the financial service account.

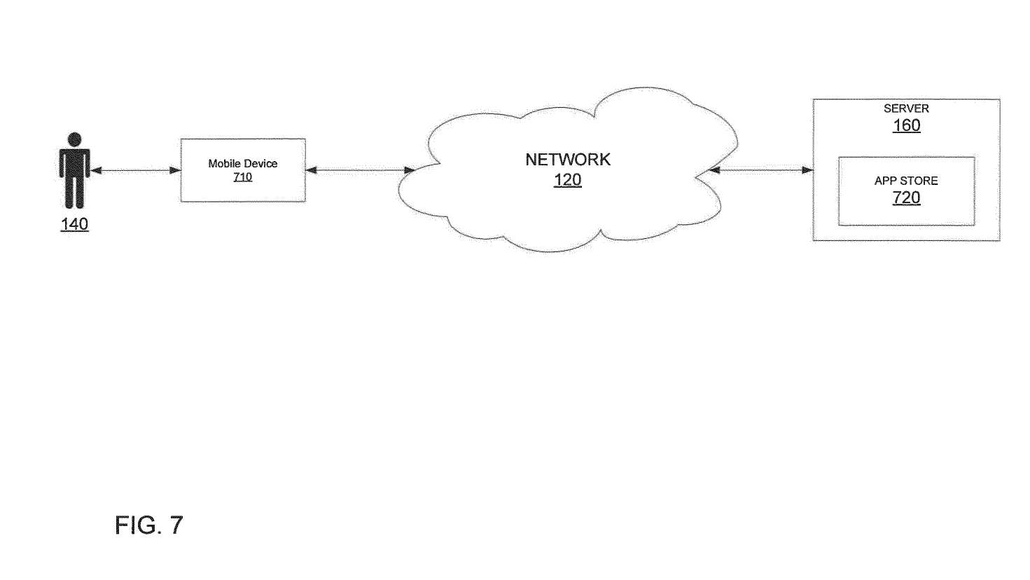

FIG. 7 illustrates an exemplary embodiment involving mobile device applications and a mobile device application store (app store) 720. A non-transitory computer readable medium in this scenario may store instructions that when executed by one or more processors, provides the systems and methods in accordance with embodiments of the present disclosure as described above. The non-transitory computer readable medium may exist in a server 160 that connects to a device (e.g., client 150), which in certain embodiments may be a mobile device 710, such as a smart phone, a tablet, a GPS, a personal digital assistant, a wearable computing device, etc. Mobile device 710 may be owned or otherwise associated with user 140.

In one aspect, mobile device 710 is connected to network 120, but communications between device 710 and network 120 may involve other connections or other communication protocols, e.g. Universal Serial Bus (USB), Bluetooth, hardware plug-ins, Wi-Fi and other wireless local area network (WLAN) protocols, and 3G/4G/LTE and other wide area network (WAN) protocols. App store 720 provides an interface through which user 140 may obtain a copy of stored on a medium within, for example, server 160. In one aspect, the program may be executed by one or more processors to perform one or more processes consistent with the disclosed embodiments.

User 140 may interact with the app store using an interface executing on mobile device 710. In one aspect, user 140 may request a copy of the program stored in the app store 720 using mobile device 710. In response, server 160 may collect and transmit the program from app store 720 to mobile device 710. In this manner, mobile device 710 may store and execute program instructions that perform one or more processes consistent with the disclosed embodiments.

Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims. For example, the process steps shown in FIGS. 3-6 are not limited to the sequences described above. Variations of these sequences, such as the removal and/or the addition of other process steps may be implemented without departing from the spirit and scope of the present disclosure.

Additionally, the present disclosure may be applied to financial service accounts other than credit cards accounts. Any financial service provider that provides financial service accounts to customers may employ methods, systems, and articles of manufacture consistent with certain principles related to the present disclosure.

Furthermore, although aspects of the present disclosure are described as being associated with data stored in memory and other storage mediums, one skilled in the art will appreciate that these aspects can also be stored on or read from other types of computer-readable media, such as secondary storage devices, like hard disks, floppy disks, or CD-ROM; the Internet; or other forms of RAM or ROM.

What is claimed:

1. A method for delivering personalized deals, the method comprising:
configuring a financial service account associated with a user including at least one criteria for providing the user with deals associated with one or more merchants;
monitoring, by one or more processors, a plurality of financial transactions associated with the user;
identifying, by the one or more processors, one or more deals associated with at least one merchant based on the monitored transactions and at least one criteria;
generating, by the one or more processors, a personalized deal package based on the identified one or more deals.

2. The method of claim 1, wherein configuring the financial service account is based on a profile of the user that includes at least one of: user selections of purchase categories for which the user wishes to receive deals, a credit history of the user, an employment history of the user, penalty fee conditions associated with the financial service account, or financial service account usage conditions.

3. The method of claim 1, wherein monitoring the plurality of financial transactions comprises monitoring transactions performed using the configured financial account and at least one other financial service account associated with the user.

4. The method of claim 3, wherein the at least one other financial service account associated is provided to the user by a financial service provider not associated with the configured financial service account.

5. The method of claim 1, further comprising:
determining a geographic location of the user; and
generating the personalized deal package based on the identified one or more deals relevant to the user's determined location.

6. The method of claim 1, further comprising:
associating a customer identifier with the configured financial service account;
receiving a request for a personalized deal package identifying the customer identifier;
identifying the configured financial service account based on the request identifying the customer identifier; and
providing the requested personalized deal package to the requestor.

7. The method of claim 6, further comprising:
generating the customer identifier when the user accesses the configured financial service account online via a user device;
storing the customer identifier in at least one file associated with the user device; and
receiving the request for a personalized deal package based on the requestor's access of at least the one file.

8. A system for delivering personalized deals, comprising:
memory storing instructions; and
at least one processor configured to execute the instructions to perform operations comprising:
configuring a financial service account associated with a user including at least one criteria for providing the user with deals associated with one or more merchants;
monitoring a plurality of financial transactions associated with the user;
identifying one or more deals associated with at least one merchant based on the monitored transactions and at least one criteria;
generating a personalized deal package based on the identified one or more deals.

9. The system of claim 8, wherein configuring the financial service account is based on a profile of the user that includes at least one of: user selections of purchase categories for which the user wishes to receive deals, a credit history of the user, an employment history of the user, penalty fee conditions associated with the financial service account, or financial service account usage conditions.

10. The system of claim 8, wherein monitoring the plurality of financial transactions comprises monitoring transactions performed using the configured financial account and at least one other financial service account associated with the user.

11. The system of claim 10, wherein the at least one other financial service account associated is provided to the user by a financial service provider not associated with the configured financial service account.

12. The system of claim 8, wherein the at least one processor is configured to execute the instructions to perform operations further comprising:
determining a geographic location of the user; and
generating the personalized deal package based on the identified one or more deals relevant to the user's determined location.

13. The system of claim 8, wherein the at least one processor is configured to execute the instructions to perform operations further comprising:
associating a customer identifier with the configured financial service account;
receiving a request for a personalized deal package identifying the customer identifier;
identifying the configured financial service account based on the request identifying the customer identifier; and
providing the requested personalized deal package to the requestor.

14. The system of claim 13, wherein the at least one processor is configured to execute the instructions to perform operations further comprising:
generating the customer identifier when the user accesses the configured financial service account online via a user device;
storing the customer identifier in at least one file associated with the user device; and
receiving the request for a personalized deal package based on the requestor's access of at least the one file.

15. A non-transitory computer readable medium storing instructions that, when executed by at least one processor, cause the at least one processor to perform operations comprising:
configuring a financial service account associated with a user including at least one criteria for providing the user with deals associated with one or more merchants;
monitoring a plurality of financial transactions associated with the user;
identifying one or more deals associated with at least one merchant based on the monitored transactions and at least one criteria;
generating a personalized deal package based on the identified one or more deals.

16. The medium of claim 15, wherein configuring the financial service account is based on a profile of the user that includes at least one of: user selections of purchase categories for which the user wishes to receive deals, a credit history of the user, an employment history of the user, penalty fee conditions associated with the financial service account, or financial service account usage conditions.

17. The medium of claim 15, wherein monitoring the plurality of financial transactions comprises monitoring transactions performed using the configured financial account and at least one other financial service account associated with the user.

18. The medium of claim 17, wherein the at least one other financial service account associated is provided to the user by a financial service provider not associated with the configured financial service account.

19. The medium of claim 15, wherein the memory stores instructions that cause the at least one processor to perform operations further comprising:
associating a customer identifier with the configured financial account;
receiving a request for a personalized deal package identifying the customer identifier;
identifying the configured financial service account based on the request identifying the customer identifier; and
providing the requested personalized deal package to the requestor.

20. The medium of claim 19, wherein the memory stores instructions that cause the at least one processor to perform operations further comprising:
associating a customer identifier with the configured financial service account;
receiving a request for a personalized deal package identifying the customer identifier;
identifying the configured financial service account based on the request identifying the customer identifier; and
providing the requested personalized deal package to the requestor.

21. The medium of claim 20, wherein the memory stores instructions that cause the at least one processor to perform operations further comprising:
generating the customer identifier when the user accesses the configured financial service account online via a user device;
storing the customer identifier in at least one file associated with the user device; and
receiving the request for a personalized deal package based on the requestor's access of at least the one file.
